(19) United States
(12) Patent Application Publication
(10) Pub. No.: US 2024/0375140 A1
(43) Pub. Date: Nov. 14, 2024

(54) SPRAY GUN CAPABLE OF PREVENTING SPATTERING

(71) Applicant: A-TECH HANDOK CO., LTD., Busan (KR)

(72) Inventor: Myung Kook KANG, Busan (KR)

(21) Appl. No.: 18/689,134

(22) PCT Filed: Feb. 11, 2022
(86) PCT No.: PCT/KR2022/002114

§ 371 Date: Mar. 5, 2024

(30) Foreign Application Priority Data
Sep. 6, 2021 (KR) 10-2021-0118592
Sep. 29, 2021 (KR) 10-2021-0129227
Feb. 8, 2022 (KR) 10-2022-0016480

(51) Int. Cl. B05B 12/18; B05B 1/00; B05B 1/04; B05B 1/28; B05B 9/01

(52) U.S. Cl. CPC B05B 12/18; B05B 1/005; B05B 1/044; B05B 1/28; B05B 9/01

(57) ABSTRACT

A spray gun capable of preventing spattering includes: a head in which a spray nozzle for spraying paint is embedded; and a handle formed at the lower portion of the head, wherein side air nozzles having vertical slits are provided on both sides of the head, and an upper air nozzle and a lower air nozzle, each having a horizontal slit, are provided at the upper and lower portions of the head so that air simultaneously sprayed from the upper air nozzle, the lower air nozzle, and the side air nozzles blocks the spattering of paint, which is sprayed from the spray nozzle, while surrounding the periphery thereof in a square shape.

### BACKGROUND

The present invention relates to a spray gun, and more specifically, to a spray gun capable of preventing spattering, which can prevent spattering of paint sprayed from the spray gun.

The work of applying and painting paint or waterproofing agents is carried out throughout the industry.

In the past, workers directly performed painting with hair pencils, brushes, and rollers, but now it is common to perform painting with spray guns.

The spray gun is a gun-shaped device that may be gripped by the worker and may directly spray paint on a painting surface, and sprays the paint in a dust (microdroplet) form through a nozzle attached to a front side of the spray gun so that the paint is adhered to the painting surface.

However, the painting work using the spray gun has a problem of causing contamination of buildings, parked vehicles, or other facilities due to spattered paint dust.

Moreover, approximately 30% of the paint sprayed by the spray gun is spattered during the painting work, which not only causes paint loss by the amount of spattering, but also reduces the adhesion rate to the painting surface, thereby causing problems such as deterioration in efficiency of painting work, loss of labor, and increase in costs.

To solve the problem, a number of methods have been proposed to prevent spattering of paint.

In a device for preventing spattering, a method of mounting a cover surrounding the nozzle or forming an air curtain by spraying air around the nozzle is typically used.

Particularly, in the method of using an air curtain, air nozzles are arranged around the spray nozzle to form an air curtain.

Most of the conventional air nozzles are formed in a hole shape, and a plurality of air nozzles are arranged in a circular shape around the spray nozzles at regular intervals.

In such a structure, since a cross-section of the spray air has a circular shape, it overlaps with the circular air coming out of the adjacent air nozzle, and thus the thickness of an air curtain to be formed is not constant and thick and thin portions are alternately repeated.

Therefore, the thick portion blocks the paint well, but blocking of spattering the paint may be incomplete in a region where the air curtain is thin.

In addition, the shape of the application area of the paint sprayed from the spray nozzle has a vertically long elliptical shape, whereas the air curtain has a circular shape, so that the air nozzles have to be arranged in a very large circular shape to cover the long elliptical shape.

Moreover, the application area of the sprayed paint varies depending on the type of work, environment, and spray gun. That is, since the horizontal width is almost constant but the vertical width is changed, there is an inconvenience in that an air nozzle capable of forming an air curtain suitable for the width needs to be separately mounted.

### SUMMARY OF THE INVENTION

Accordingly, the present invention has been developed in order to solve the above-described problems, and an object of the present invention is to provide a spray gun capable of preventing spattering, in which slit-shaped air nozzles are arranged in a square form to form an air curtain having a predetermined thickness while surrounding a spray nozzle, thereby completely preventing spattering.

Another object of the present invention is to provide a spray gun capable of preventing spattering, which may adjust inclination angles of air nozzles at upper and lower ends such that a vertically elliptical shape of an application surface may be covered even if the shape of the application surface is changed.

To achieve the above object, according to the present invention, there is provided a spray gun capable of preventing spattering, in which the spray gun may include: a head in which a spray nozzle for spraying paint is installed; and a handle formed at the lower portion of the head, wherein side air nozzles having vertical slits are provided at both sides of the head, and an upper air nozzle and a lower air nozzle, each having a horizontal slit, are provided at the upper and lower portions of the head, respectively, so that air simultaneously sprayed from the upper air nozzle, the lower air nozzle, and the side air nozzles blocks the spattering of paint, which is sprayed from the spray nozzle, while surrounding the periphery thereof in a square form.

According to the present invention described above, the following effects are obtained.

First, the air curtain having a predetermined thickness, which is sprayed from the side air nozzles, the upper air nozzle, and the lower air nozzle, surrounds an elliptical paint application surface, so that it is possible to completely prevent the spattering of the paint.

Second, the inclination angles of the upper air nozzle and the lower air nozzle are adjusted even if the application surface of the sprayed paint varies depending on the type of work, the environment, the spray gun, and the nozzle, so that the size of the air curtain may be adjusted to sufficiently cover the spattering.

Third, the air may be uniformly sprayed from the air nozzle by the spreader or the separator.

Fourth, the amount of spattered paint is extremely reduced and waste of paint is minimized, so that costs may be reduced and a working environment of a worker may be greatly improved to prevent safety accidents.

### BRIEF DESCRIPTION OF DRAWINGS

FIG. 1 is a perspective view showing an appearance of a spray gun capable of preventing spattering according to one embodiment of the present invention.

FIG. 2 is a longitudinal-sectional perspective view of a side surface of the present invention shown in FIG. 1.

FIG. 3 is a longitudinal-sectional perspective view of a front surface of the present invention shown in FIG. 1.

FIG. 4 is a cross-sectional perspective view of the present invention shown in FIG. 1.

FIG. 5 is an exploded perspective view showing one embodiment of an air nozzle of the present invention shown in FIG. 2.

FIG. 6 is an exploded perspective view showing another embodiment of the air nozzle of the present invention shown in FIG. 2.

FIG. 7 is a plan view showing another embodiment of a gasket of the present invention shown in FIG. 6.

FIG. 8 is a front view showing a spraying state of paint and air curtain of the present invention shown in FIG. 1.

FIG. 9 is a longitudinal-sectional view showing a spray gun capable of preventing spattering according to another embodiment of the present invention.

FIG. 10 is a sectional view along line A-A of the present invention shown in FIG. 9.

FIG. 11 is an operation state view of an inclination angle adjustment unit shown in FIG. 9.

FIG. 12 is a longitudinal-sectional view showing a spray gun capable of preventing spattering according to still another embodiment of the present invention.

FIG. 13 is a sectional view along line B-B of the present invention shown in FIG. 12.

FIG. 14 is an operation state view of the inclination angle adjustment unit of the present invention shown in FIG. 12.

FIG. 15 is a front view showing still another embodiment of an air nozzle of the present invention.

### DETAILED DESCRIPTION OF THE INVENTION

Hereinafter, one embodiment of the present invention will be described in more detain with reference to accompanying drawings.

For reference, the description with reference to the drawings is intended to make the present invention easier to understand, and the scope of the present invention is not limited thereby. In addition, when detailed descriptions of related known technologies are considered to unnecessarily cloud the gist of the present invention in describing the present invention below, the detailed descriptions will be omitted.

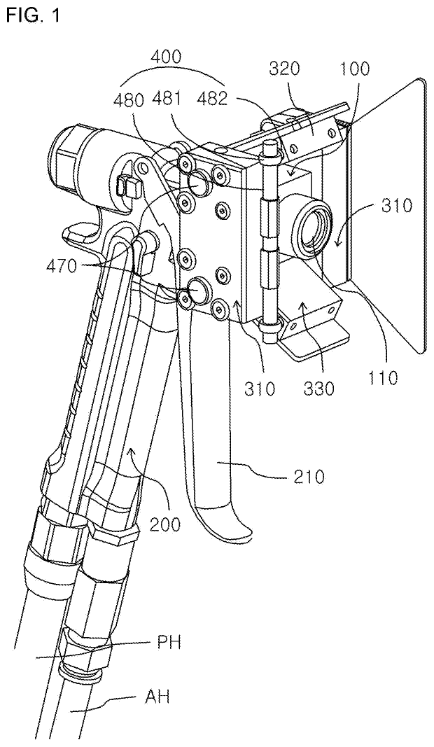

FIG. 1 is a perspective view showing an appearance of a spray gun capable of preventing spattering according to one embodiment of the present invention.

The present invention may largely include a head 100 in which a paint nozzle is installed to spray a painting material or paint, a handle 200 formed on a lower surface of the head 100, side air nozzles 310 attached to both sides of the head 100, and an upper air nozzle 320 and a lower air nozzle 330 attached to an upper portion and a lower portion of the head 100, respectively, and may further include an inclination angle adjustment unit 400 capable of adjusting inclination angles of the upper air nozzle 320 and the lower air nozzle 330.

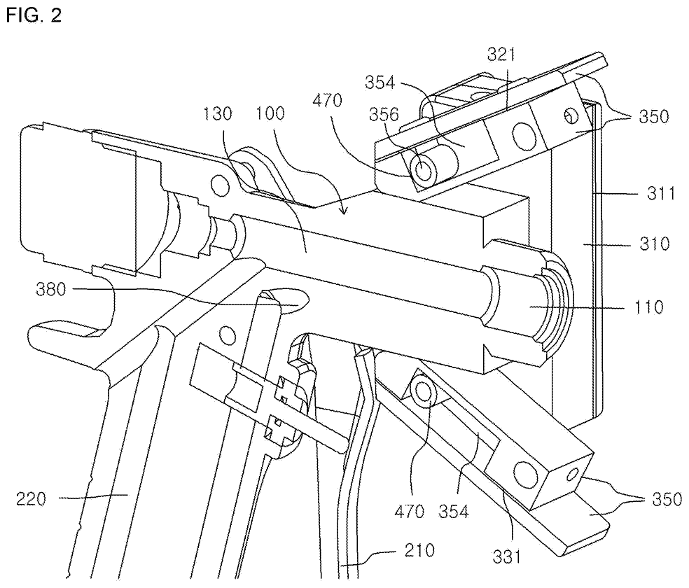

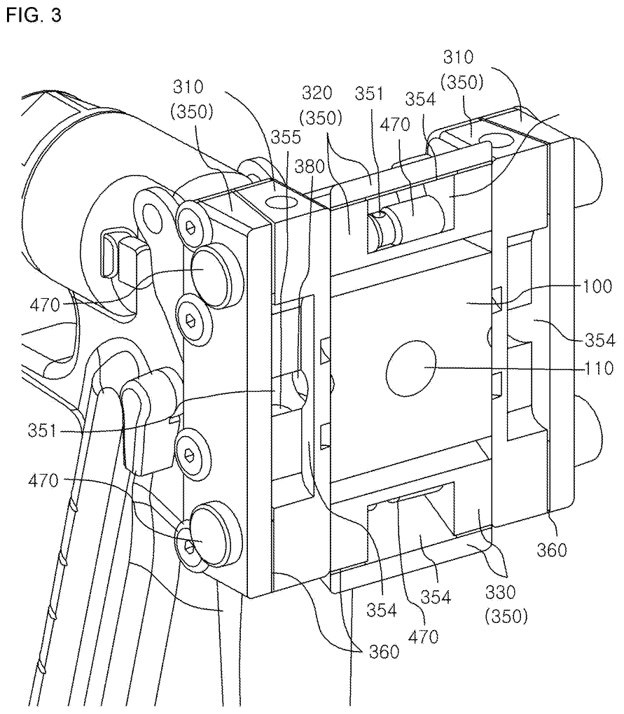

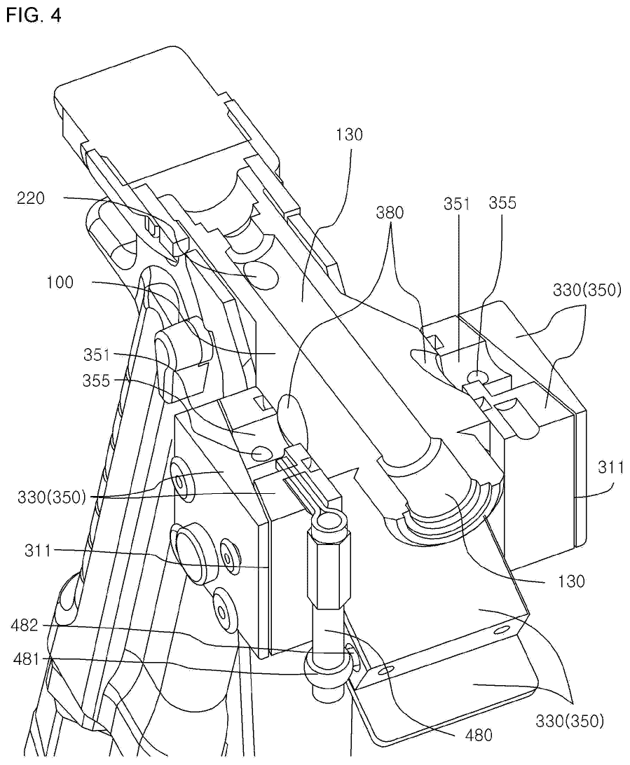

First, the head 100 and the handle 200 will be described with reference to FIGS. 2 to 4. FIG. 2 is a longitudinal-sectional perspective view of a side surface of the present invention shown in FIG. 1, FIG. 3 is a longitudinal-sectional perspective view of a front surface of the present invention shown in FIG. 1, and FIG. 4 is a cross-sectional perspective view of the present invention shown in FIG. 1.

The head 100 corresponds to a body of the spray gun, has a substantially square block shape, is formed at a center of a front end thereof with a paint nozzle 110 capable of spraying a painting material or paint, and has a lower portion connected to the handle 200.

In addition, the inside of the head 100 is formed with a paint supply path 130 connected to the paint nozzle 110 along a longitudinal direction.

The handle 200 may have a structure protruding from or coupled to the lower portion of the head 100 such that a worker may work while gripping the handle.

The handle 200 may have a hollow shape, and may be coupled to communicate with the paint supply path 130 or may be formed inside the handle with a paint injection path 220 communicating with the paint supply path.

In this case, a paint hose PH may be coupled to the lower portion of the handle 200 and connected to the paint injection path 220.

Moreover, an air injection path 230 may be formed inside the handle 200, and the air injection path 230 may be connected to an external air hose AH.

In addition, a lever 210 is swingably coupled to one side of the handle 200 to pull the lever 210 with a gripping force, thereby opening the paint nozzle 110 and spraying the paint.

Furthermore, by pulling the lever 210, air may be sprayed by opening the air injection path 230 to be described later.

According to the present invention, an air distribution path 380 is formed inside the head 100 such that the air injected through the air injection path 230 may be transferred and supplied to the side air nozzles 310 and the upper and lower air nozzles 330.

The air distribution path 380 communicates with an upper end of the air injection path 230 and is branched in a ‘V’ shape to communicate with the outside while extending by passing through a left side surface and a right side surface of the head 100.

In this case, through-holes 351 of the side air nozzles 310, which will be described later, attached to the left side surface and a rear side surface of the head 100, communicate with the air distribution path 380 so that the air may be supplied into the side air nozzles 310.

However, since the structures of the head 100 and the handle 200 described above are well-known, a detailed description thereof will be omitted, and any structure different from the described structure may be used.

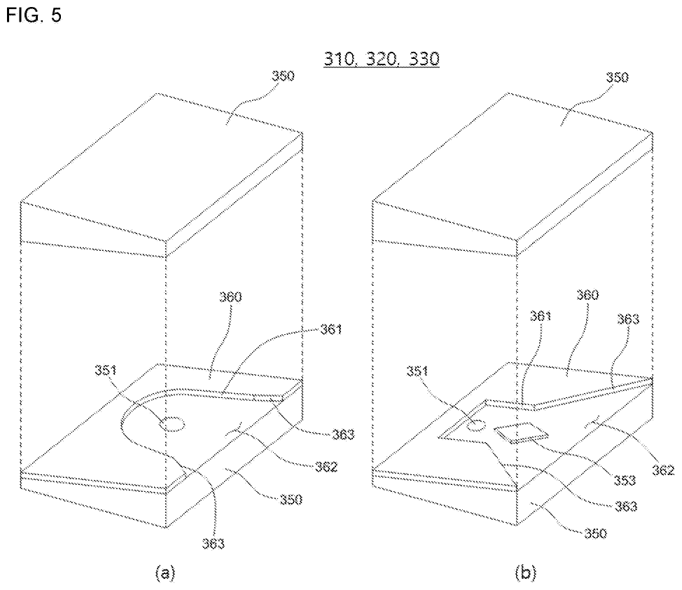

Next, the side air nozzles 310, the upper air nozzle 320, and the lower air nozzle 330, which are core technical matters of the present invention, will be described with reference to FIG. 5. FIG. 5 is an exploded perspective view showing one embodiment of an air nozzle of the present invention shown in FIG. 2.

The term “air nozzle” in the present invention is a term collectively referring to the side air nozzles, the upper air nozzle, and the lower air nozzle.

The side air nozzles 310 are coupled to both sides, that is, a left side surface and a right side surface of the head 100 to spray air, thereby forming air curtains on the left and right sides.

In addition, the upper air nozzle 320 and the lower air nozzle 330 are coupled to the upper surface and the lower surface of the head 100, respectively, to spray air, thereby forming air curtains at the upper side and the lower side.

That is, air nozzles are provided in directions of 12, 3, 6, and 9 o'clock of the head 100 to form air curtains while surrounding the paint nozzle 110 in a substantially rectangle form.

The side air nozzles 310, the upper air nozzle 320, and the lower air nozzle 330 may have a structure as shown in FIG. 5(a).

Specifically, each of the side air nozzle, the upper air nozzle, and the lower air nozzle may have a sandwich structure in which a gasket 360 is inserted between two nozzle bodies 350.

The nozzle body 350 may have a flat plate shape having a predetermined thickness, and a pair of the nozzle bodies 350 are provided while making close contact with each other. In this case, a contact surface of the nozzle body 350 may be a horizontal surface, but as shown in the drawing, the contact surface may have an inclined surface to guide a path of the sprayed air to be inclined outward, thereby spreading the air curtain.

In addition, the gasket 360 has the same cross-sectional shape as the nozzle body 350 with a constant thickness, and is formed with a cut groove 361 having an opening 362 by being cut forward. In this case, the cut groove 361 may have a ‘U’, ‘V’, or ‘angled U’ shape.

Preferably, inclined portions 363 may be formed at both sides of the opening 362 of the cut groove 361, and are inclined in a direction in which the opening 362 extends.

Furthermore, a through-hole 351 through which the air is supplied is formed in a center of any one of the nozzle bodies 350. In this case, the through-hole 351 is located inside the cut groove 361.

For reference, as described above, through-holes 351 of the side air nozzles 310 may directly communicate with the air distribution path 380.

Due to the structure as described above, two nozzle bodies 350 are spaced apart from each other by a width corresponding to a thickness of the gasket 360, a nozzle space is formed at a portion where the cut groove 361 is located, and the nozzle body 350 and the opening 362 form slits 311, 321, and 331 having a long rectangular shape.

Therefore, when compressed air is introduced through the through-hole 351, the compressed air may be sprayed forward through the slits 311, 321, and 331, and the air may be spread in a fan shape at a predetermined angle by the inclined portions 363.

In this case, the slits 321 and 331 of the upper air nozzle 320 and the lower air nozzle 330 are all disposed to be long horizontally, and the slit 311 of the side air nozzle 310 is disposed to be long vertically.

That is, since the slits 311, 321, and 331 are disposed to form a substantially rectangle form, the air sprayed from each of the slits 311, 321, and 331 forms a rectangular air curtain (barrier).

According to the present invention, as shown in FIG. 5(b), the side air nozzles 310 and the upper and lower air nozzles 330 may further include a spreader 353.

Specifically, each of the side air nozzle, the upper air nozzle, and the lower air nozzle may have a sandwich structure in which a gasket 360 is inserted between two nozzle bodies 350, which is the same as the above-described structure.

Moreover, the cut groove 361 may be formed in the gasket 360, and inclined portions 363 may be formed at both sides of the opening 362 of the cut groove 361. Obviously, the inclined portions 363 extend in a direction in which the opening 362 extends. However, the inclined portions 363 may be formed to be relatively longer than a depth of the cut groove 361.

Furthermore, the through-hole 351 is formed in a center of any one of the nozzle bodies 350.

In this case, a spreader 353 is preferably formed between the through-hole 351 and the opening 362. Specifically, the spreader 353 is formed at a center of the opening 362 between the inclined portions 363.

The spreader 353 may protrude from a surface of any one of nozzle bodies 350 and may have a step-like structure. Due to the spreader 353, the sprayed air may be distributed to both sides without being concentrated at the center.

In addition, the spreader 353 may have a rhombus shape as shown in the drawings, but is not limited thereto, and may have various shapes such as a circle, an oval, a triangle, and a trapezoid.

In this case, a protruding height of the spreader 353 is the same as the thickness of the gasket 360 so that there is no gap between the spreader 353 and the other nozzle body 350, or the protruding height of the spreader 353 is lower than the thickness of the gasket 360 to form a gap between the spreader 353 and the other nozzle body 350 so that the air may be partially discharged through the gap.

The spreader 353 may allow the compressed air introduced from the through-hole 351 to be uniformly sprayed when the compressed air is sprayed through the slits 311, 321, and 331.

This is because, when the spreader 353 is not present, the sprayed air tends to be mainly concentrated at the center of the slits 311, 321, and 331, and a density of the air may be relatively reduced at edges of the slits 311, 321, and 331.

Therefore, a flow of air concentrated at the center of the opening 362 is guided to both sides of the opening 362 while being divided into both sides about the spreader 353.

Moreover, since the compressed air is also partially sprayed into the gap formed between the spreader 353 and the nozzle body 350, the compressed air may be uniformly sprayed entirely along the longitudinal direction of the slits 311, 321, and 331.

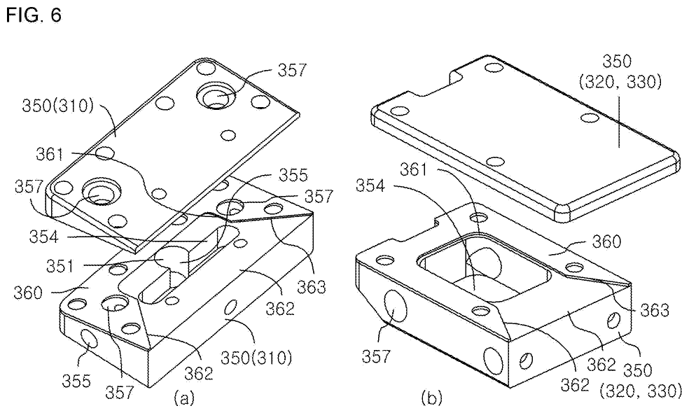

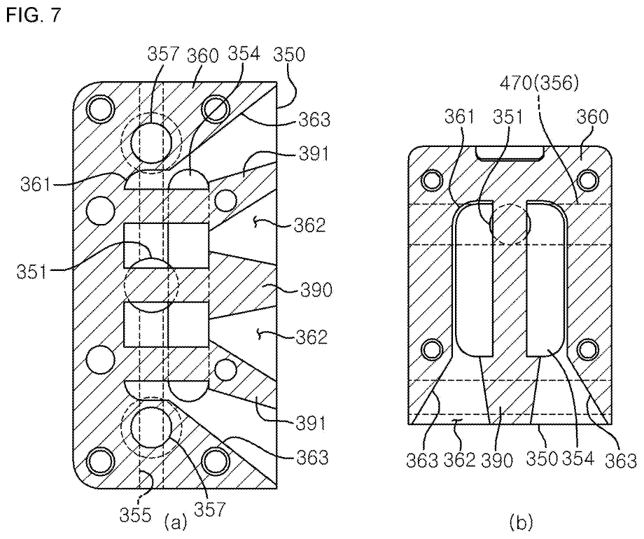

Hereinafter, another embodiment of the air nozzle of the present invention will be described with reference to FIG. 6. FIG. 6 is an exploded perspective view showing another embodiment of the air nozzle of the present invention shown in FIG. 2. FIG. 7 is a plan view showing another embodiment of a gasket of the present invention shown in FIG. 6. In this case, FIG. 6(a) shows the side air nozzle of the present invention, FIG. 6(b) shows the upper or lower air nozzle of the present invention, FIG. 7(a) shows the gasket inserted into the side air nozzle, and FIG. 7(b) shows the gasket inserted into the upper or lower air nozzle.

First, the side air nozzle 310 has a structure in which the gasket 360 is inserted between two nozzle bodies 350 as described above.

However, the through-hole 351 is formed in any one of the nozzle bodies 350 of the side air nozzles 310, that is, the nozzle body 350 provided adjacent to a side surface of the head 100, and a chamber 354 having a groove shape is formed at one side of the through-hole 351. In this case, the through-hole 351 communicates with the air distribution path 380.

The chamber 354 has an elongated shape and communicates with the through-hole 351 while overlapping the through-hole 351.

In addition, a vertical flow path 355 is formed through the nozzle body 350 and across the through-hole 351.

As shown in FIG. 6(b), a rectangular groove-shaped chamber 354 is formed in any one of the nozzle bodies 350 of the upper air nozzle 320 or the lower air nozzle 330, that is, the nozzle body 350 provided adjacent to the upper surface and the lower surface of the head 100.

In addition, a horizontal flow path 356 is formed through the nozzle body 350 and across the chamber 354. In this case, both ends of the horizontal flow path 356 respectively communicate with the vertical flow path 355.

That is, a pair of vertical flow paths 355 formed at both sides of the side air nozzle 310, the horizontal flow path 356 formed at the upper air nozzle 320, and the horizontal flow path 356 formed at the lower air nozzle 330 may form a rectangular air flow path.

Therefore, the air supplied to the air distribution path 380 is introduced into the chamber 354 of the side air nozzle 310 through the through-hole 351 of the side air nozzle 310, is temporarily accommodated therein, and is sprayed through the slit 311 of the side air nozzle 310.

Moreover, some of the air supplied to the through-holes 351 of the side air nozzles 310 is transferred upward and downward through the vertical flow path 355 so as to be introduced into the horizontal flow paths 356, and the air introduced into the horizontal flow path 356 is transferred to the chamber 354 of the upper air nozzle 320 and the lower air nozzle 330, and then is sprayed through the slits 321 and 331 of the upper air nozzle 320 and the lower air nozzle 330.

Meanwhile, the gasket 360 inserted into the side air nozzle 310 may have a structure in which the cut groove 361 and an inclined surface 363 are formed as shown in FIG. 6(a), but preferably, a separator 390 may be further formed inside the cut groove 361 as shown in FIG. 7(a).

The separator 390 may protrude long from a bottom of the cut groove 361 to the opening 362 to separate the flow of air when the air accommodated in the chamber 354 is sprayed through the opening 362.

In this case, the separator 390 is formed across the through-hole 351 and an upper portion of the chamber 354, and an end portion of the separator 390 has a trapezoidal shape to expand the opening 362 together with the inclined portion 363, thereby spreading the sprayed air. That is, the separator 390 may serve similarly to the spreader 353 described above.

An auxiliary separator 391 may be further formed between the separator 390 and the inclined portion 363. In the case of the side air nozzle 310, since a length of the opening 362 is long, the auxiliary separator 391 is further added to separate the flow of the sprayed air more finely, so that the air may be uniformly sprayed as a whole without being concentrated in a specific direction.

Moreover, the gasket 360 inserted into the upper air nozzle 320 and the lower air nozzle 330 may also be as shown in FIG. 6(b), but preferably, the gasket 360 may have a structure in which the separator 390 is formed inside the cut groove 361 as shown in FIG. 7(b).

That is, the separator 390 may protrude inside the cut groove 361 of the upper air nozzle 320 and the lower air nozzle 330, and an end portion of the separator 390 may also be formed in a trapezoidal shape.

However, in the case of the upper air nozzle 320 and the lower air nozzle 330, since the length of the opening 362 is short, the auxiliary separator 391 may not be provided.

According to the present invention, the upper air nozzle 320 and the lower air nozzle 330 may be fixed while being inclined at a predetermined angle, but preferably, have a structure capable of adjusting inclination angles.

To this end, the upper air nozzle 320 and the lower air nozzle 330 may be rotatably provided by a rotary flow path shaft 470.

The rotary flow path shaft 470 is fixed to horizontally cross the upper and lower portions of the head 100, and the upper air nozzle 320 and the lower air nozzle 330 may be rotatably coupled to the fixed rotary flow path shaft 470.

However, as shown in the drawings, it is preferable that both ends of the rotary flow path shaft 470 are fixed between the side air nozzles 310, and the rotary flow path shaft 470 horizontally extends by passing through the upper air nozzle 320 and the lower air nozzle 330 so that the upper air nozzle 320 and the lower air nozzle 330 may be rotated.

In more detail, the length of the side air nozzle 310 may be formed to be longer than a height of the head to protrude upward and downward of the head 100, and the both ends of the rotary flow path shaft 470 may be connected to each other while being fixed to upper and lower ends of the side air nozzle 310.

Shaft holes 357 may be formed at the upper and lower ends of the side air nozzle 310 such that the rotary flow path shaft 470 may be coupled while extending by passing through the shaft holes.

Moreover, the rotary flow path shaft 470 extends by passing across the chamber 354 of the upper air nozzle 320 and the lower air nozzle 330. To this end, shaft holes 357 may be also formed at the upper air nozzle 320 and the lower air nozzle 330 so that the rotary flow path shaft 470 may extend by passing through the shaft hole. Obviously, the shaft hole 357 of the side air nozzle and the shaft holes 357 of the upper air nozzle 320 or the lower air nozzle 330 communicate with each other so that the rotary flow path shaft 470 simultaneously extends by passing through the shaft holes.

In this case, the rotary flow path shaft 470 is formed in a hollow shape and has a through-hole 351 formed at an outer circumferential surface thereof, in which the through-hole 351 is located inside the chamber 354, both ends of the rotary flow path shaft 470 meet the vertical flow path 355, and transfer holes (not shown) are formed at both ends of the rotary flow path shaft so as to respectively communicate with the vertical flow path 355.

Therefore, the air transferred to the vertical flow path 355 may be introduced into the rotation flow path shaft 470 through the transfer holes, and the introduced air may be discharged through the through-hole 351, accommodated in the chamber 354 of the upper air nozzle 320 and the lower air nozzle 330, and then sprayed through the slits 321 and 331.

That is, the rotary flow path shaft 470 may serve as the horizontal flow path 356 while rotatably supporting the upper air nozzle 320 and the lower air nozzle 330.

Next, an inclination angle adjustment unit 400 capable of adjusting inclination angles of the air sprayed from the upper air nozzle 320 and the lower air nozzle 330 will be described with reference to FIG. 1.

The inclination angle adjustment unit 400 may include lifting adjustment bolts 480, adjustment nuts 481, and an adjustment shaft 482.

The lifting adjustment bolt 480 is formed in a rod shape and has a male screw thread on an outer circumferential surface thereof so as to be vertically rotatable in front of the side air nozzle 310. In this case, a hexagonal rotation head is formed on the outer circumferential surface of the lifting adjustment bolt 480.

In addition, the adjustment nuts 481 are screw-coupled to upper and lower ends of the lifting adjustment bolt 480, respectively.

Moreover, the adjustment shaft 482 is coupled to the adjustment nuts 481, and the adjustment shaft 482 is rotatably inserted into a front side of the nozzle bodies 350 of the upper air nozzle 320 and the lower air nozzle 330.

Therefore, when the lifting adjustment bolt 480 is rotated to one side by holding the rotation head, the adjustment nut 481 may move vertically to increase inclinations of the upper air nozzle 320 and the lower air nozzle 330.

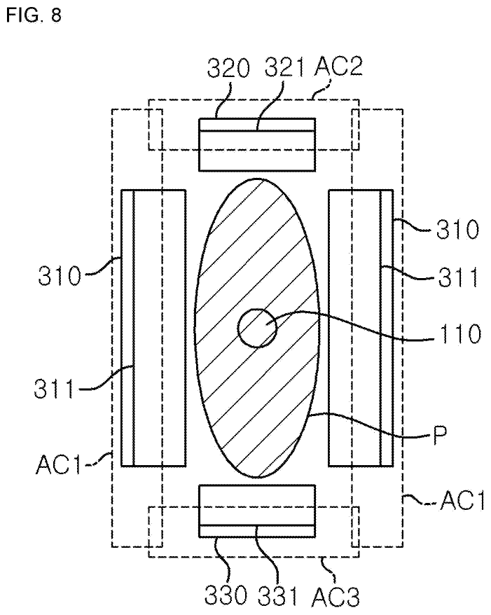

Hereinafter, an operation state of the present invention will be described with reference to FIG. 8. FIG. 8 is a front view showing a spraying state of paint and air curtain of the present invention shown in FIG. 1.

When the worker holds the handle 200 and presses the lever 210, the paint is sprayed like fog having fine particles through the paint nozzle 110. Generally, the sprayed paint is formed in a vertically long elliptical form as shown in FIG. 8.

Simultaneously, when the air is supplied through the air injection path 230, the air is branched through the air distribution path 380, is transferred to the chamber 354 of the side air nozzle 310 through the through-hole 351 of the side air nozzle 310, and then is sprayed through the slit 311 of the side air nozzle 310, and the air is spread by the inclined portions 363.

Moreover, some of the air introduced through the through-hole 351 of the side air nozzle 310 is introduced into the rotary flow path shaft 470 through the horizontal flow path 356, that is, the transfer hole of the rotary flow path shaft 470 while passing through the vertical flow path 355, and the introduced air is introduced into the chambers 354 of the upper air nozzle 320 and the lower air nozzle 330 through the through-hole 351 of the rotary flow path shaft 470, and then is sprayed through the slits 321 and 331 of the upper air nozzle 320 and the lower air nozzle 330.

In this case, the air sprayed from the side air nozzles 310 forms vertically long side air curtains AC1 at left and right sides of a paint application surface P, the air sprayed from the upper air nozzle 320 forms a horizontally long upper air curtain AC2 above the paint application surface P, and the air sprayed from the lower air nozzle 330 forms a horizontally long lower air curtain AC3 below the paint application surface P.

Therefore, the side air curtains AC1, the upper air curtain AC2, and the lower air curtain AC3 form a vertically long air rectangular air curtain as shown in the drawings, and surround the elliptical paint application surface, thereby completely blocking the spattering.

In particular, since the compressed air may be uniformly sprayed by the spreader 353 or the separator 390 and the auxiliary separator 391, an air barrier having a predetermined thickness may be formed, so that the paint may not be spattered even at a boundary point where the paint and the air curtain make contact with each other, but may be pushed by air pressure to move forward, thereby completely blocking the spattering.

When the paint application surface P is changed, for example, when a vertical length of the ellipse is increased or decreased, the inclination angles of the upper air nozzle 320 and the lower air nozzle 330 are adjusted to completely surround the ellipse.

When the lifting adjustment bolt 480 is rotated in one direction, the upper air nozzle 320 and the lower air nozzle 330 are rotated in a direction in which the inclination angles are increased about the rotary flow path shaft 470, thereby blocking the spattering having a longer elliptical application surface.

On the contrary, when the lifting adjustment bolt is rotated in the other direction, the upper air nozzle 320 and the lower air nozzle 330 are rotated in a direction in which the inclination angles are decreased about the rotary flow path shaft 470, thereby blocking the spattering having a shorter elliptical application surface.

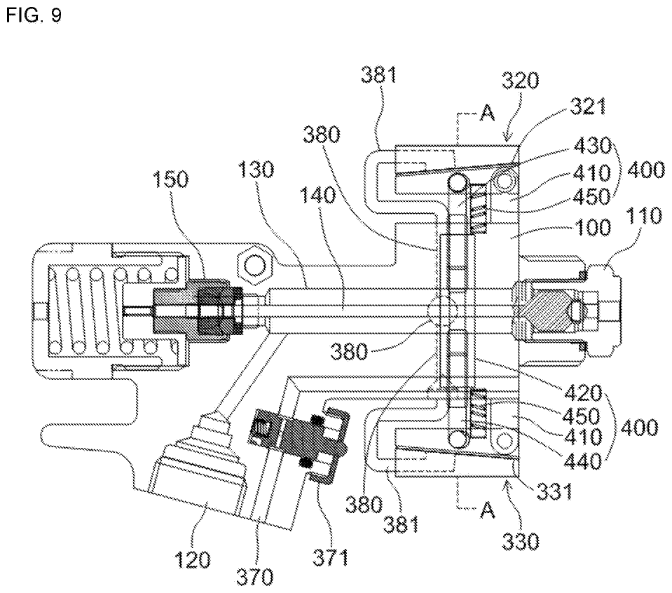

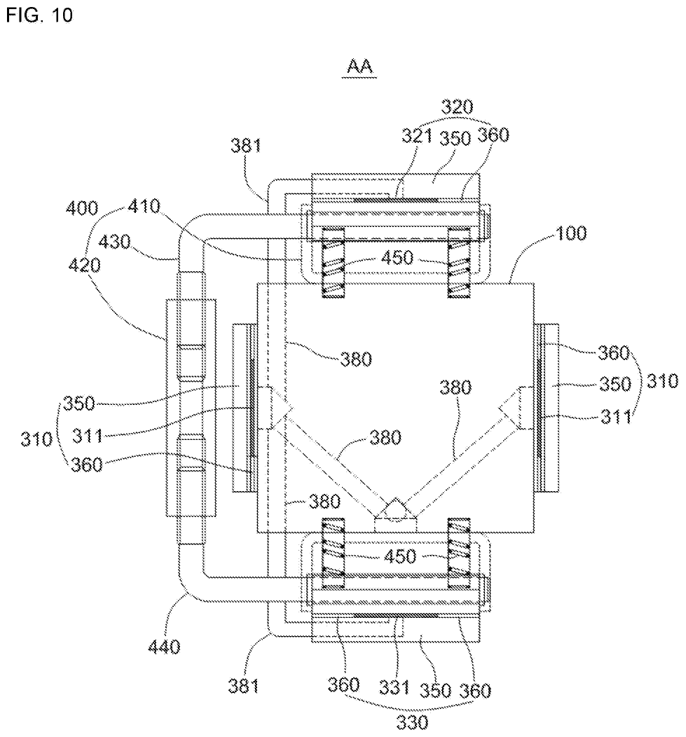

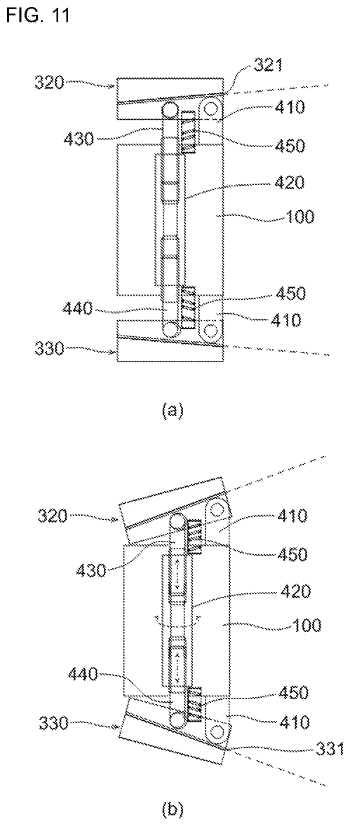

Hereinafter, another embodiment of the present invention will be described with reference to FIGS. 9 to 11. FIG. 9 is a longitudinal-sectional view showing a spray gun capable of preventing spattering according to another embodiment of the present invention, FIG. 10 is a sectional view along line A-A of the present invention shown in FIG. 9, and FIG. 11 is an operation state view of an inclination angle adjustment unit shown in FIG. 9.

Another embodiment of the present invention may include a head 100, a handle 200, side air nozzles 310, an upper air nozzle 320, and a lower air nozzle 330, and may further include an inclination angle adjustment unit 400.

First, the head 100 has a paint nozzle 110 formed at the center of a front end thereof to spray paint or paint, and has a lower portion formed with a connector 120 to which a paint hose for supplying paint is connected.

A paint supply path 130 is formed inside the head 100 to communicate with the connector 120 in a longitudinal direction and to be connected to the paint nozzle 110.

In addition, an opening/closing rod 140 for opening and closing the paint nozzle 110 is provided on the paint supply path 130 along the longitudinal direction, and the opening/closing rod 140 is provided at a rear of the head 100 and a forward/backward moving unit 150 capable of moving the opening/closing rod 140 forward and backward is installed therein.

In this case, the forward/backward moving unit 150 is operated by a lever 210 to be described later.

Moreover, an air injection path 230 capable of supplying air into the head 100 is formed.

Next, the handle 200 may protrude from the lower portion of the head 100 such that the worker may hold and work.

The handle 200 may be formed in a hollow shape to be coupled in communication with the connector 120, and may have a structure in which the paint hose is connected to the connector 120 while being inserted into the handle 200.

Moreover, the lever 210 is swingably coupled to one side of the handle 200 and the lever 210 is pulled with a gripping force to operate the forward/backward moving unit 150, thereby opening the paint nozzle 110 to spray the paint and opening the air injection path 230 to spray the air.

Next, the side air nozzles 310, the upper air nozzle, and the lower air nozzle will be described.

However, since the side air nozzles 310, the upper air nozzle 320, and the lower air nozzle 330 are the same as those described above, only the different air supply paths will be described.

The air injection path 230 extends to the inside of the head 100.

In addition, the air injection path 370 is branched into a plurality of air distribution paths 380 to be connected to the side air nozzles 310 and the upper air nozzle 320.

That is, the air distribution path 380 may be branched to both sides to communicate with the side air nozzles 310 and supply the air, and the air distribution path 380 connected to any one of the side air nozzles 310 may be vertically branched again to communicate with the upper air nozzle 320 and the lower air nozzle 330.

In this case, an air tube 381 may be further provided to connect the upper air nozzle 320 and the lower air nozzle 330. A lower end of the air tube 381 is connected to an upper end of the air distribution path 380, and an upper end of the air tube 381 communicates with each of the through-holes 351 while extending by passing through the nozzle body 350 of the upper air nozzle 320.

In addition, an upper end of the other air tube 381 is connected to a lower end of the air distribution path 380, and a lower end of the other air tube 381 communicates with each of the through-holes 351 while extending by passing through the nozzle body 350 of the lower air nozzle 330.

Accordingly, the air supplied to the air injection path 370 may be distributed by the air distribution path 380 to be uniformly supplied to the through-holes 351 of the side air nozzles 310, the upper air nozzle 320, and the lower air nozzle 330.

For reference, an air valve 371 may be provided in the air injection path 370 to open and close the air injection path 230 by the operation of the lever 210.

Next, the inclination angle adjustment unit will be described.

The inclination angle adjustment unit 400 may include hinge brackets 410, an adjustment body 420, an upper adjustment bar 430, and a lower adjustment bar 440.

The hinge bracket 410 is formed in a ‘angled U’ shape by bending a flat plate, and is attached to each of an upper surface and a lower surface of the head 100.

In addition, both sides of the upper air nozzle 320 and the lower air nozzle 330 are rotatably coupled between the hinge brackets 410. In this case, the hinge brackets 410 may be coupled to the front of the upper air nozzle 320 and the lower air nozzle 330, and a separate hinge shaft 411 may rotatably support the upper air nozzle 320 and the lower air nozzle 330 while extending by passing through the upper air nozzle 320 and the lower air nozzle 330.

Moreover, the adjustment body 420 is vertically provided at one side of the head 100, is formed in a hollow tube shape, and has a female screw thread formed on an inner circumferential surface thereof.

Further, the upper adjustment bar 430 and the lower adjustment bar 440 are screw-coupled to upper and lower ends of the adjustment body 420, respectively.

The upper adjustment bar 430 and the lower adjustment bar 440 may be rod members having a ‘reversed-L’ shape, each of which has one end inserted into the adjustment body 420 and the other end hinge-coupled while horizontally extending by passing through the center of side surfaces of the upper air nozzle 320 and the lower air nozzle 330.

In this case, a male screw thread is formed at a lower end of the upper adjustment bar 430 to be inserted into an upper portion of the adjustment body 420 and screw-coupled to a female screw thread, and a male screw thread is also formed at an upper end of the lower adjustment bar 440 to be inserted into a lower portion of the adjustment body 420 and screw-coupled to a female screw thread.

Importantly, the male screw threads of the upper adjustment bar 430 and the lower adjustment bar 440 are spirally formed in opposite directions. That is, when a left screw is formed on the upper adjustment bar 430, a right screw is formed on the lower adjustment bar 440.

Therefore, when the adjustment body 420 is rotated in one direction, the upper adjustment bar 430 and the lower adjustment bar 440 are operated to be moved away from or close to each other.

Preferably, springs 450 are inserted between the head 100 and the upper air nozzle 320 and between the head 100 and the lower air nozzle 330, respectively, to elastically support the upper air nozzle 320 and the lower air nozzle 330. That is, the upper air nozzle 320 and the lower air nozzle 330 maintain an inclined open state.

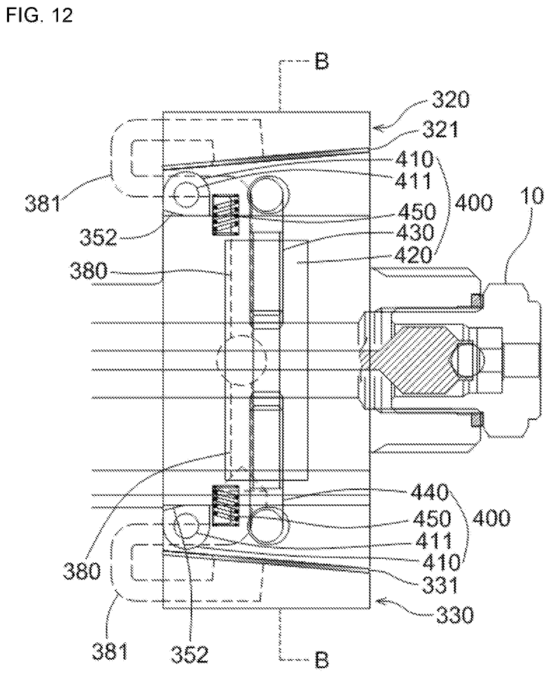

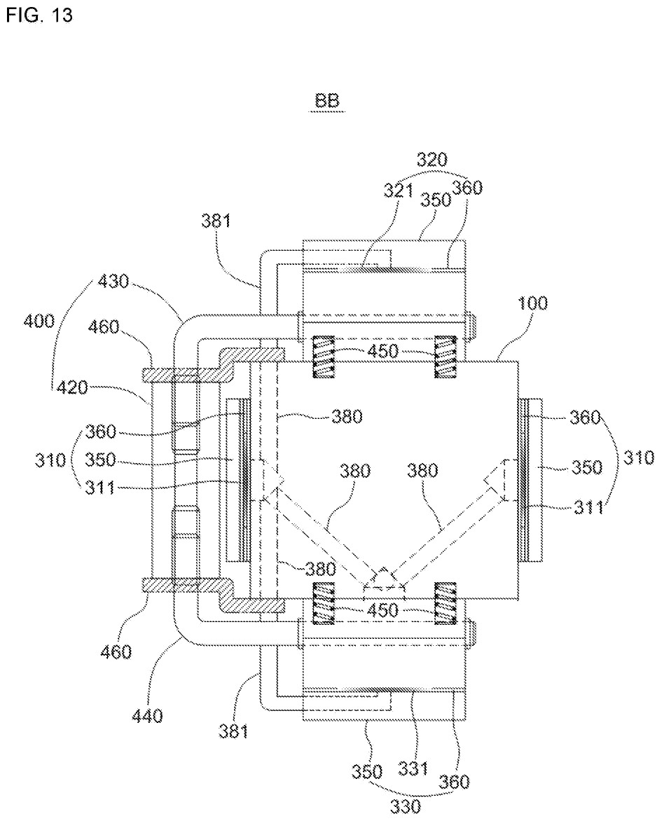

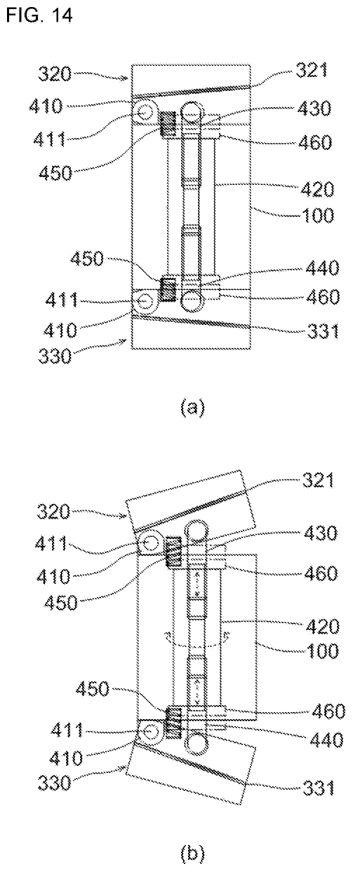

Hereinafter, still another embodiment of the present invention will be described with reference to FIGS. 12 to 14. FIG. 12 is a longitudinal-sectional view showing a spray gun capable of preventing spattering according to still another embodiment of the present invention, FIG. 13 is a sectional view along line B-B of the present invention shown in FIG. 12, and FIG. 14 is an operation state view of the inclination angle adjustment unit of the present invention shown in FIG. 12.

According to still another embodiment of the present invention, the inclination angle adjustment unit 400 may have a different structure.

The upper air nozzle 320 and the lower air nozzle 330 may be rotatably coupled to the upper surface and the lower surface of the head 100 without the above-described ‘angled U’-shaped hinge bracket.

To this end, hinge brackets 410 are formed on upper and lower surfaces of the head 100 so as to protrude while being spaced apart from each other to both sides, respectively, a hinge shaft 411 extends by passing through the upper air nozzle 320 or the lower air nozzle 330, and both ends of the hinge shaft 411 are supported by the hinge brackets 410, so that the upper air nozzle 320 and the lower air nozzle 330 are rotatably provided about the hinge shaft 411.

In this case, unlike the above-described embodiment, the hinge shaft 411 extends by passing through the rear of the upper air nozzle 320 and the lower air nozzle 330.

In addition, inclined chamfers 352 may be formed at the rear of the upper air nozzle 320 and the lower air nozzle 330 by chamfering corner portions that make contact with the head 100.

The chamfers 352 provide a space for allowing the upper air nozzle 320 and the lower air nozzle 330 to rotate, and restricts the upper air nozzle 320 and the lower air nozzle 330 so as not to be inclined at a predetermined angle or greater.

Moreover, the adjustment body 420, the upper adjustment bar 430, and the lower adjustment bar 440 may be provided in the same or similar manner as described above.

However, the springs 450 are provided between the hinge bracket 410 and the upper adjustment bar 430 and between the hinge bracket 410 and the lower adjustment bar 440 to elastically support the upper air nozzle 320 and the lower air nozzle 330, respectively.

Importantly, the adjustment body 420 may be separately fixed by a pair of fixing brackets 460 such that sagging does not occur.

The fixing bracket 460 may bend the flat plate twice as shown in the drawings to have a cross-section having a shape substantially like ‘a right-angled Z’.

One of the fixing brackets 460 is horizontally coupled to the upper surface of the head 100 and has an end portion extending outward, and the other is horizontally coupled to the lower surface of the head 100 and has an end portion extending outward.

In addition, the adjustment body 420 is held while being inserted between the fixing brackets, so that the adjustment body 420 may be rotated without moving vertically.

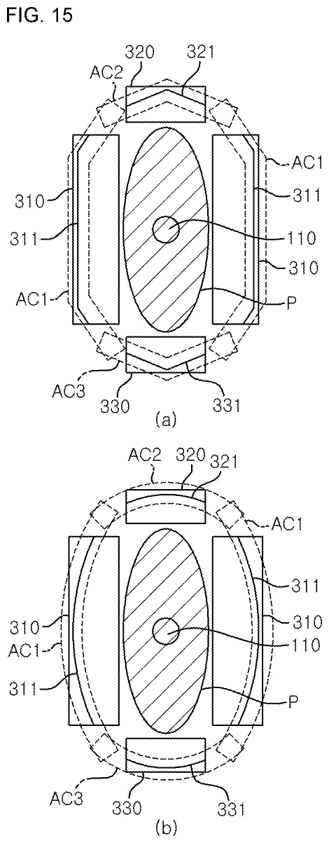

Hereinafter, another embodiment of the air nozzle according to the present invention will be described. FIG. 15 is a front view showing still another embodiment of an air nozzle of the present invention.

The slits 311, 321, and 331 of the side air nozzle 310, the upper air nozzle 320, and the lower air nozzle 330 may have a linear shape as described above, but may have a bending or curved shape as shown in FIG. 15.

The slit 311 of the side air nozzle 310 may have a shape such as ‘a slantly opened right bracket’ as shown in FIG. 15(a), or may have a shape such as an arc-shaped curve, for example, ‘a right parenthesis’ as shown in FIG. 15(b).

In addition, the slits 321 and 331 of the upper air nozzle 320 and the lower air nozzle 330 may have a shape such as ‘an angle bracket’ as shown in FIG. 15(a), or may have a shape such as an arc-shaped curve, for example, ‘a right parenthesis’ as shown in FIG. 15(b).

Alternatively, the slit 311 of the side air nozzle 310 may be made equal to ‘a slantly opened right bracket’ and the slits 321 and 331 of the upper air nozzle 320 and the lower air nozzle 330 may be made equal to ‘a right parenthesis’, or the slit 311 of the side air nozzle 310 may be made equal to ‘a right parenthesis’ and the slits 321 and 331 of the upper air nozzle 320 and the lower air nozzle 330 may be made equal to ‘an angle bracket’.

That is, a slit of any shape capable of preventing spattering while surrounding the application surface P of the paint may be possible.

Although a representative embodiment of the present invention has been described above with reference to the drawings, those skilled in the art may perform various applications and modifications within the scope of the present invention based on the above contents. Therefore, the scope of the present invention should not be limited to the described embodiments, but should be defined by the scope of claims and equivalents thereof, which will be described later.

1. A spray gun capable of preventing spattering, the spray gun comprising: a head in which a spray nozzle for spraying paint is installed; and a handle formed at a lower portion of the head,
wherein side air nozzles having vertical slits are provided at both sides of the head, and an upper air nozzle and a lower air nozzle, each having a horizontal slit, are provided at upper and lower portions of the head, respectively,
so that air simultaneously sprayed from the upper air nozzle, the lower air nozzle, and the side air nozzles blocks the spattering of paint, which is sprayed from the spray nozzle, while surrounding a periphery of the paint in a square form.

2. The spray gun of claim 1, wherein each of the upper air nozzle, the lower air nozzle, and the side air nozzles has a structure including a pair of nozzle bodies, which have a flat shape and a through-hole formed in any one thereof, and a gasket, which is inserted between the nozzle bodies and has a cut groove having a ‘U’ or ‘angled U’ shape, so that the air supplied through the through-hole is sprayed through the slits formed by the cut groove.

3. The spray gun of claim 1, wherein inclined portions are formed at both sides of an opening of the cut groove so that the air sprayed through the slits is spread at a predetermined angle.

4. The spray gun of claim 3, further comprising a spreader formed between the inclined portions and protruding from a surface of any one of the nozzle bodies to separate a flow of the sprayed air to both sides.

5. The spray gun of claim 3, wherein a separator for separating the flow of the air protrudes from the cut groove of the gasket.

6. The spray gun of claim 5, wherein one or more auxiliary separators protrude between the separator and both inclined portions.

7. The spray gun of claim 6, wherein the nozzle body of the side air nozzle has a chamber configured to spray the air through the slits while temporarily accommodating the air supplied through the through-hole.

8. The spray gun of claim 2, wherein an air distribution path is formed inside the head in a ‘V’ shape to transfer the air, which is supplied through an air injection path formed inside the handle, to the side air nozzles, respectively, and
the air distribution path communicates with the through-hole formed in the nozzle body of the side air nozzle.

9. The spray gun of claim 8, wherein the nozzle body of the side air nozzle has a chamber configured to spray the air through the slits while temporarily accommodating the air supplied through the through-hole.

10. The spray gun of claim 9, wherein the nozzle body of the side air nozzle has a vertical flow path which is vertically formed through the through-hole,
the nozzle bodies of the upper air nozzle and the lower air nozzle have chambers configured to spray the air through the slits while temporarily accommodating the air supplied through the through-hole,
the nozzle bodies of the upper air nozzle and the lower air nozzle have horizontal flow paths which are horizontally formed through the through-hole, and
each of both ends of the horizontal flow path communicates with the vertical flow path so that the air is supplied.

11. The spray gun of claim 10, wherein the nozzle bodies of the upper air nozzle and the lower air nozzle have rotary flow path shafts which extend by passing through the chambers, respectively, in which both ends of the rotary flow path shaft are respectively coupled to the side air nozzles, so that the upper air nozzle and the lower air nozzle are rotatable,
the rotary flow path shaft is formed in a hollow shape and has a through-hole formed on an outer circumferential surface thereof to communicate with an inside of the rotary flow path shaft, and has transfer holes formed at both ends thereof to communicate with the vertical flow path, and
the inside of the rotary flow path shaft serves as the horizontal flow path.

12. The spray gun of claim 2, wherein an air injection path formed inside the handle extends downward through the inside of the head,
an air distribution path is formed at an end portion of the air injection path in a ‘V’ shape toward the side air nozzle so as to vertically extend by passing through one side of the head, and
upper and lower ends of the air distribution path are connected to through-holes of the upper air nozzle and the lower air nozzle, respectively, by an air tube so as to supply the air.

13. The spray gun of claim 2, further comprising an inclination angle adjustment unit provided at a front side of the head with a length that is extendable and retractable, and having upper and lower ends hinge-coupled to the upper air nozzle and the lower air nozzle, respectively, so as to adjust inclinations of the upper air nozzle and the lower air nozzle.

14. The spray gun of claim 13, wherein the inclination angle adjustment unit includes lifting adjustment bolts vertically and rotatably provided at one sides of the upper air nozzle and the lower air nozzle, adjustment nuts screw-coupled to both ends of the lifting adjustment bolt, and an adjustment shaft having one end coupled to the adjustment nut and the other end inserted into the nozzle bodies of the upper air nozzle and the lower air nozzle.

15. The spray gun of claim 1, wherein hinge brackets having an ‘angled U’ shape are respectively coupled to an upper surface and a lower surface of the head, in which the upper air nozzle and the lower air nozzle are rotatably coupled to the hinge brackets, and
wherein an inclination angle adjustment unit with a length that is extendable and retractable is further provided at one side of the head, in which the inclination angle adjustment unit has upper and lower ends hinge-coupled to the upper air nozzle and the lower air nozzle, respectively, so as to adjust inclinations of the upper air nozzle and the lower air nozzle.

16. The spray gun of claim 1, wherein hinge brackets protrude from both sides of an upper surface and a lower surface of the head, respectively, and a hinge shaft horizontally extending by passing through the upper air nozzle and the lower air nozzle is coupled to each hinge bracket so that the upper air nozzle and the lower air nozzle are rotatable, and
an inclination angle adjustment unit with a length that is extendable and retractable is further provided at one side of the head, in which the inclination angle adjustment unit has an upper ends hinge-coupled to the upper air nozzle and a lower end hinge-coupled to the lower air nozzle, so as to adjust inclinations of the upper air nozzle and the lower air nozzle.

17. The spray gun of claim 15, wherein the inclination angle adjustment unit includes an adjustment body formed in a hollow tube shape and having a female screw thread formed therein, an upper adjustment bar formed in a ‘reversed-L’ shape and having an upper end hinge-coupled to the upper air nozzle and a lower end formed with a male screw thread to be screw-coupled to an upper portion of the adjustment body while being inserted into the upper portion of the adjustment body, and a lower adjustment bar formed in a ‘reversed-L’ shape and having a lower end hinge-coupled to the lower air nozzle and an upper end formed with a male screw thread to be screw-coupled to a lower portion of the adjustment body while being inserted into the lower portion of the adjustment body.

18. The spray gun of claim 17, wherein the upper surface and the lower surface of the head are coupled to a pair of fixing brackets extending outward, respectively, and the adjustment body is held and fixed between the fixing brackets.

19. The spray gun of claim 1, wherein the slit is formed in any one of a straight line, an arc-shaped curve, ‘a slantly opened right bracket’, and ‘an angle bracket’.

20. The spray gun of claim 16, wherein the inclination angle adjustment unit includes an adjustment body formed in a hollow tube shape and having a female screw thread formed therein, an upper adjustment bar formed in a ‘reversed-L’ shape and having an upper end hinge-coupled to the upper air nozzle and a lower end formed with a male screw thread to be screw-coupled to an upper portion of the adjustment body while being inserted into the upper portion of the adjustment body, and a lower adjustment bar formed in a ‘reversed-L’ shape and having a lower end hinge-coupled to the lower air nozzle and an upper end formed with a male screw thread to be screw-coupled to a lower portion of the adjustment body while being inserted into the lower portion of the adjustment body.
